(19) United States
(12) Patent Application Publication
(10) Pub. No.: US 2004/0035859 A1
(43) Pub. Date: Feb. 26, 2004

(54) Method and products for microwave roasting

(76) Inventors: Rickey Childress, Fairhope, AL (US); Steven Grossman, Selma, AL (US)

Correspondence Address: Gregory M. Friedlander, Gregory M. Friedlander & Associates, P.C., 11 South Florida Street, Mobile, AL, 36606-1984, US

(21) Appl. No.: 10/644,502

(22) Filed: Aug. 20, 2003

Related U.S. Application Data
(60) Provisional application No. 60/405,123, filed on Aug. 21, 2002.

(51) Int. Cl. H05B 6/64

(52) U.S. Cl. 219/679

(57) ABSTRACT

The invention is a method making a food product expandable in the presence of microwave energy. The product is a pellet made from a milled flour, a milled starch, an oil coating. The milled flour and starch are held together by water. A crucial step in the process is coating the product with a microwave heatable substance, preferably oil. It is also important in practice to include spices within the product and in the coating. Prior to microwaving the product it is packaged in a microwavable container which is preferably a breathable plastic such as polyester which is resistant to heat and contains the moisture and heat from the process while not exploding from the pressure. The pellet may be partially, but not completely microwaved prior to beginning and are separated from one another before the microwaving process.

### PRIORITY STATEMENT

This is a utility patent claiming priority on U.S. provisional patent application No. 60/405,123 filed Aug. 21, 2002.

### BACKGROUND OF THE INVENTION

The present invention relates to microwavable foods and packages, and more particularly to products which may be packaged for cooking or roasting in a microwave oven, and a method for using same.

### PRIOR ART

Fried foods and fried chips are well known in the art. Cooking articles with microwave energy is commonplace. A wide variety of packages have been proposed to utilize microwave energy to heat and cook various foods. For example, U.S. Pat. Nos. 5,097,107, 5,008,024, 5,044,777, 5,919,390 and 4,571,337, as well as other U.S. patents. The packages provide means for evenly distributing microwave heat so that a large percentage of kernels are popped and few of the popped kernels are overcooked. The patents relate other advantages of the packages, such as ease of handling, proper expansion as kernels are popped, and cooling advantages. Many microwavable popcorn containers are comprised of bags made of kraft paper and possibly a polymeric inner layer. Kraft paper has been found to be a suitable material for utilizing microwave energy to cook food.

Other patents exist relating to microwave packages that assist in transferring microwave heat into thermal heat, which helps brown and evenly cook foods, such as U.S. Pat. No. 4,267,420.

It is widely recognized that the molecular friction resulting from the high frequency oscillation of microwave ovens fails to impart the proper amount of crispness to foods normally expected to possess such a quality. Consequently, when such foods are heated in a microwave oven, they do not possess the requisite degree of eye appeal and taste appeal that one normally expects. Various attempts have been made to correct for the inherent lack of browning or crispening when employing microwave heating, primarily aimed toward modifying the microwave oven or using edible coatings on the food itself, but also directed towards specific packaging requirements for various foods.

U.S. Pat. No. 5,919,390 issued to Childress describes a method of packaging nuts and seeds which allows for the products to be evenly heated.

### GENERAL DISCUSSION OF THE INVENTION

Heretofore, no patent has addressed a suitable package for roasting flour-starch pellets in a microwave oven in a manner that will produce an appealing texture and crunchiness.

In order to allow for the end user to prepare a hot potato chip type product, a package which at least partially converts microwave heat into thermal heat is desirable. In addition, pellets which may be expanded that are tightly packed together tend to roast unevenly in a microwave, so this product is designed in order to allow enough room for proper roasting, while still providing adequate amounts of product for consumption.

There are several novel improvements taught in this invention.

1. It is not necessary to use any paper outer shell on these new products. The absence of a paper outer shell is a feature of the products. Not having the kraft outer shell enables the consumer to see the product “pop”. This adds to the enjoyment of the experience, and it also gives the consumer better control of the micro-waving process. With microwave popcorn (in the opaque paper bags), one can never be sure when the product is ready. With clear polyester bags, one can see exactly when the popping is complete.

2. The product is a high quality low fat product. The industry has yet to find a satisfactory low fat chip. Olestra scared away too many consumers, and other low fat formula equate with low taste. The problem is that in the cooking phase (of other chips), the chips (or pellets) absorb huge amounts of oil/fat. Typically, snack chips are 25-40% fat. With this process, a thin film of partially hydrogenated canola oil is sprayed on the surface of the pellet, but the pellet does NOT absorb or need not absorb any excess oil. There is enough oil on the chip so that when microwaved and consumed, one gets the desired “fried” taste from the small amount of oil that clings to the chip. In fact, the products have LESS than 1 g of fat per bag; but since it is more than ½ g, packaging requires that it be listed as 1 g on the ‘Nutritional Statement’.

3. The product may be made with a variety of pellets. The pellets already contain some flavorings and colors. However, just microwaving such pellets would not produce commercial products. This process adds the oil as well as salt and other seasonings.

4. Microwaving allows the product to be served fresh. The process places the product in the microwave, turns it, cooks it, provides visual and auditory cues.

It is therefore an object of the invention to provide a product which may be microwave roasted to produce an edible cooked and expanded pellet origin product. It is another object to combine this product with a container appropriate for the preparation of the product.

These and other objects and advantages of the invention will become better understood hereinafter from a consideration of the specification with reference to the accompanying drawings forming part thereof, and in which like numerals correspond to parts throughout the several views of the invention.

### BRIEF DESCRIPTION OF THE DRAWINGS

For a further understanding of the nature and objects of the present invention, reference should be made to the following detailed description taken in conjunction with the accompanying drawings in which like parts are given like reference numerals and wherein:

FIG. 1 shows a cross sectional view of a press for making pellets.

FIG. 2 is a perspective view of the press shown in FIG. 1.

FIG. 3 shows a method of preparing pellets for packaging.

FIG. 4 shows packaging for the pellets modified to separate the pellets into chambers.

FIG. 5 shows how the packaging may provide for spacing for expansion upon heating.

FIG. 6 shows how the packaging may be modified upon packaging the product.

FIG. 7 shows a side view of the packaging shown in FIG. 5.

FIG. 8 shows the view of a food product which has been coated with pellet material in order to allow for microwave frying.

FIG. 9 shows an alternate top view of the packaging for the product.

FIG. 10 shows a perspective view of the packaging shown in FIG. 8.

FIG. 11 shows a side view of the package shown in FIG. 9.

FIG. 13 shows the packaging of FIG. 12 after heating and expansion of the pellets.

FIG. 14 shows a side view through the cross section 14-14 in FIG. 13.

FIG. 15 shows a side view through the cross section 15-15 shown in FIG. 13.

FIG. 16 shows a cross section through the 16-16 cross section of FIG. 12.

FIG. 17 shows a top view of the packaging holding pellets.

FIG. 18 shows a cross section of the embodiment shown in FIG. 17.

FIG. 19 shows a tumbler for coating pellets with oil and flavoring.

### DETAILED DESCRIPTION OF THE PREFERRED EXEMPLARY EMBODIMENTS

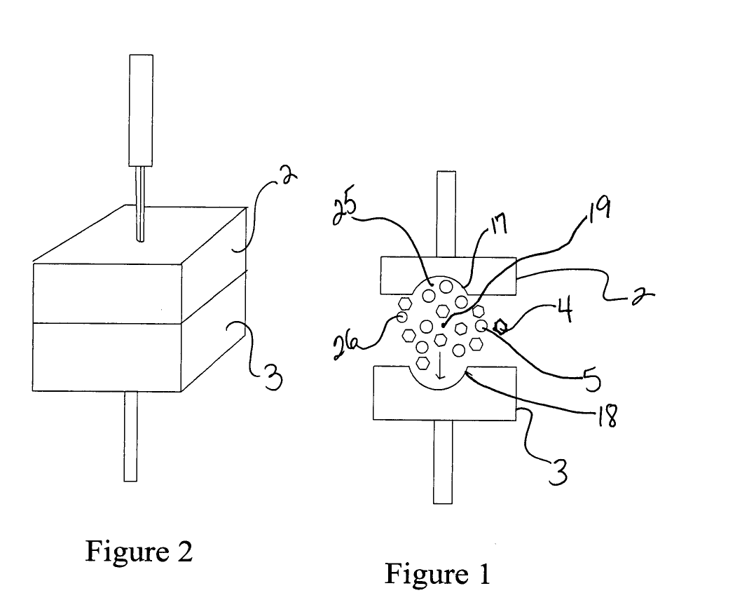

As can best be seen by reference to FIG. 1, the first step of the process is to produce a pellet 9 (shown in FIG. 3) which is made in a mold having a mold interior, cavity 25, of suitable shape and a mold top 2 and bottom 3. The mold contains portions of flour 4 and starch 5 which are held together through compression in the mold and may be further held with trace amounts of a suitable liquid solvents, here water 19 (usually water, sometimes egg derivatives or even oils). The pellet materials may be dried prior to this process or the completed pellet may be thereafter dried. A certain amount of air within the pellets is possible and desired for this process.

FIG. 2 shows how the mold may compress the pellets after the ingredients are added to form a pellet (not shown in this view) within the cavity 25 shown in FIG. 1.

Air pockets or pockets of oil may be included within the pellet as described hereinafter in order to facilitate and increase the frying and expansion process. In certain embodiments, these pockets may be avoided to prevent an explosion of the products.

The top surface 17 and bottom surface 18 may impart any desired shape to the finished product. For this discussion, flat “chips” and “rings” are used for descriptive purposes.

These pellets 9 may be based upon flour from wheat, potato, corn, rye, or similar food stuffs (or combinations thereof). The primary requirement being a starch or suitable substitute which expands upon exposure to heated oil and a flour product which is cooked to impart flavor.

In addition to the flour and starch, a flavoring substance may be added to the solvent or as separate flavoring 26. This flavoring may be dissolved or may be particles or powders.

FIG. 3 shows pellets made by extruding a paste. In this case, the materials shown in FIG. 1 are combined into a paste and then are fed through a tube 52 which dispenses set amounts of pellet material in a desired shape into a barrel as described below or onto a conveyor belt 53. Alternatively the shape may be stamped into the extruded material similar to the molding process. This material may be baked during this process or may be extruded as hardened pellets with most of the moisture removed.

After the pellets are prepared, they are modified, as shown by FIG. 3, by having an oil source 6 having a spray means 7 which produces a mist 8 of partially hydrogenated vegetable oil (or other oils, lard, butter, or other vegetable oils or combinations thereof) which will be heated as described later in this specification to give fried quality cooking, temperature and taste to the pellets.

Whether added or not added to the pellets previously as described above, the oil may contain a flavor dust or the sprayed pellets may be sprayed or rolled in a dust having desired flavors and seasonings from a seasoning source 21.

Some cooking may occur during this process to fix the oil and flavorings on the pellets.

The bag 1 may move below a pellet feed and approximately 25 g of these processed pellets are packaged into a special polyester bag. The thickness of the polyester should be in the range of 75-100 gauge. For 25 g of product, the dimensions of the bag should be approximately 8″×8″, or 7″×9.5″. The bag at this stage typically appears over 90% empty. The space defined by the interior, chamber 34, is needed for the processed pellets to expand as described later. A smaller bag would not allow the process to succeed without some modification.

The bag 1 may have a single chamber 34 which may be split into multiple chambers 44. If there is a single chamber and the pellets are all together, the pellets must be manually separated by shaking the bag. Thereafter, the bag may be placed in the center of a microwave oven. The product is cooked at full power for 20-25 seconds, depending on the wattage output of the machine. It is then turned over and shaken, and returned to the center of the microwave oven for a further 20-25 seconds.

During the 40-50 second cooking period, the processed pellets “pop” to several times their original size. The process is similar to that of popcorn, including the popping sound. The result is a bag mostly full of pellets. It is believed that a combination of the moisture and starch cause the expansion.

A food product, such as an onion flavored ring, may be a mixture made of the pellet material and then processed to add oil and flavoring to allow for the user to produce microwaved fried foods, in this case, fried onion flavored rings.

It should also be noted that the resultant snack products provide an additional benefit. These snacks are uniformly low in fat. A serving of regular potato chips (1 oz.), contains 10 g of fat, a comparable serving of these micro snacks contains only one gram of fat (or less). Thus far, the chip industry has not successfully come out with a satisfactory low fat product.

End products obtained based on variation of the initial starting products (foods made with flour and starch plus oil and flavorings) include potato chip type products, corn chip type products, cinnamon flavored products, imitation p-nuts, and the like.

The pellets may have different shapes and may have hollows (define cavities or openings) of different sizes. For example, onion rings may be copied by having the pellet made in a ring shape.

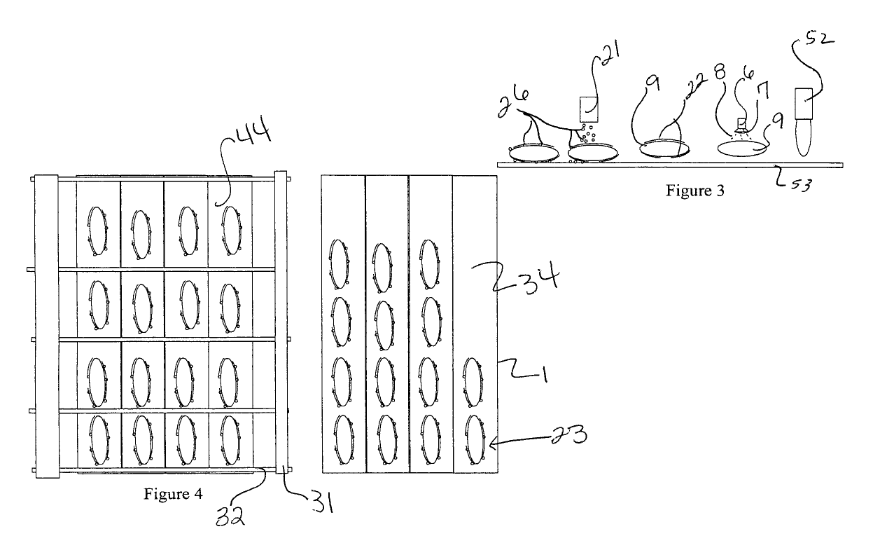

Here, there are a series of joined chambers 34 which essentially hold pellets lined up to provide separation. FIG. 4 shows how a press 31 may be used to further separate these joined chambers into smaller individual chambers 44. If the arms 32 of press 31 are heated they may be able to seal the bag 1 around these individual chambers 44 or it may provide crimping to keep the pellets 9 separated.

As described in more detail below, the individual chambers may be separated by a suitable adhesive.

One suitable adhesive is an industrial standard food grade adhesive which may be obtained, for example, from AB Fowler Co. under the trade name NaBond. Other adhesives such as dextrine or starch based adhesive may be used if desired.

In one embodiment, the oil may coat the plastic which is in contact with the pellet portions to be cooked. An expandable plastic or oil coated paper around the food to be cooked would allow the expansion of the pellet so cooked. The exterior layer 10 of the bag is a paper product that can be generally described as kraft paper, and preferably consists of a single layer of kraft paper that may be treated with a stain inhibitor.

In the preferred embodiment, no kraft paper is used or is removed prior to cooking. The polymeric layer 11 is preferably a polyester film such as polyethylene terephthalate. Alternative inner layer materials consist of other polymers that may be thinly extruded and possibly multiple layers of various polymeric materials. The preferred thickness of the inner layer 11 is about 80 gauge, and the polymeric material selected should be capable of withstanding temperatures of 350 degrees to 450 degrees Fahrenheit, as will typically be encountered in a microwave oven, without melting or otherwise contaminating or imparting flavor to the food ingredients. The polymeric layer 11 is preferably extruded into a thin, transparent film. A coating sensitive to a combination of heat and pressure, commonly referred to as a heat seal coating, may be applied to the interior surface of the polymeric film 11.

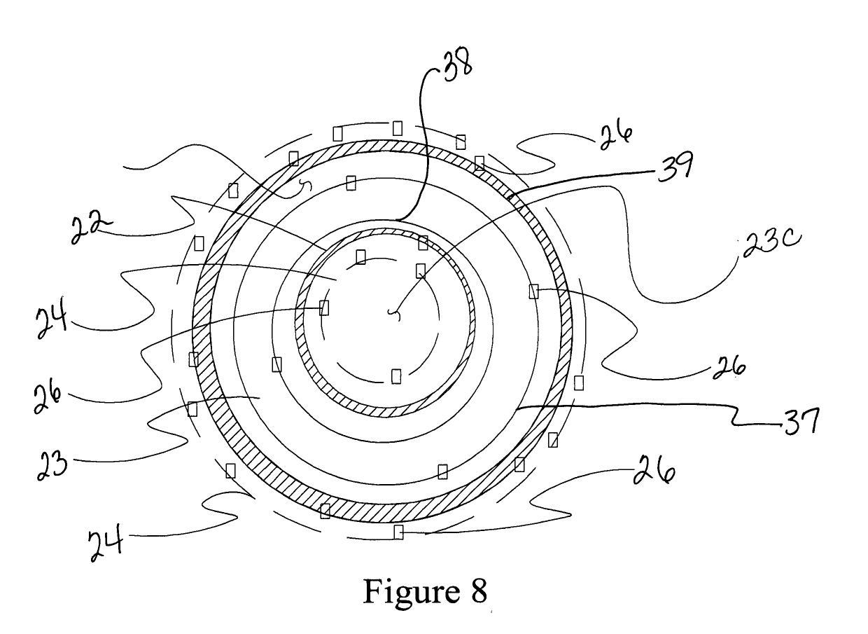

The bag may be sealed at both ends 12, 14 using any type of suitable thermoplastic adhesive 13, which can be applied using any commercially available adhesive applying equipment. As shown in FIG. 8, the bottom edge of the bag 14 is preferably sealed by a fold 40 to avoid accidental opening. The fold line 42 is shown in FIG. 8. The fold 40 is held in place by an adhesive which forms a paper-to-paper seal in addition to the interior thermoplastic seal. The top portion of the bag 12 should be sealed together with a commercially available adhesive that may be easily opened by the consumer after roasting.

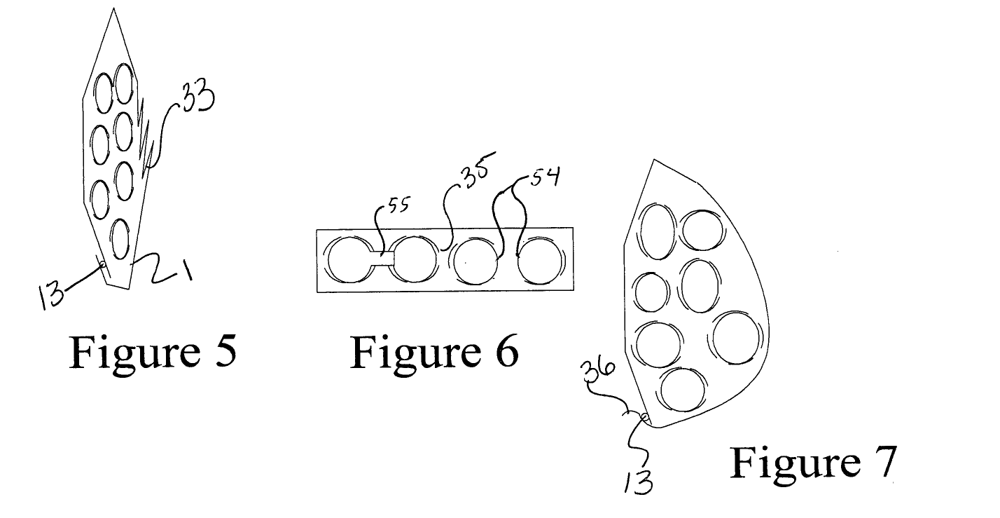

FIGS. 5, 6 and 7 shows how the microwave package, bag 1, changes with a single chamber 34 during cooking. The package bag 1 initially defines extra area, here defined by folds 33 which allows the package to expand as the pellets expand. These folds may be used to separate the pellets which expand outward to unfold the bag 1.

The bag is sealed with an adhesive 13 which leaves a flap 36 which may be pulled to separate the adhesive 13 and open the package, bag 1. This adhesive may be replaced with a hear seal, a zipper, a crimp seal or any other equivalent sealing means.

The swollen appearance of the bag 1 shown in FIG. 6 demonstrates that the package is holding heat and steam generated during microwave cooking which helps impart the desired texture and flavor to the product, cooked pellets.

The paper/polymer or polymer bag is at least partially filled with a product suitable for roasting. The ingredients are placed inside the bag in such a manner that they are evenly spread or spreadable around the internal surface area of the package. The ingredients consist principally of raw, flour and starches however, salt or other flavoring materials may be added to enhance the aromatic quality of the end product. When roasting, it has been found that about 200 mg. of salt per 3.0 oz. of pellet provides a desirable taste, but this amount may be adjusted to suit user preference. In one embodiment, the pellets are all of approximately equal size so that substantially all of the product will roast uniformly within a relatively narrow time frame. But any combination with similar cooking profiles may be used. With other products, some experimentation may be necessary to determine the optimum type of that provides a substantially uniform cooking time, without size and shape considerations that is amenable to microwave roasting is possible.

Another important consideration in the packaging of microwavable pellets is the ratio of product-to-air in the bag. Placing too many pellets in a container so that they are tightly packed together will result in uneven cooking, or cooking together of products (clumping) with uncooked portions. To avoid this the product and packaging may be adjusted to provide for separation of product while allowing for even cooking and expansion of the pellets so the product need not be carefully separated by the user and still doesn't clump, so that much of the product will fail to achieve the desired texture or crunchiness.

In FIG. 6, the package defines column pockets which fill with a 3 dimensional pellet which has ends 54 which contact and push each other so that the other portions are separated. This may result in the portions being “cooked” together. The formula of the contacting portions, here ends 54 may be modified, as by being all starch or all flour (or by having a suitable high proportion of one or the other) to maintain this separation or allow them to be easily separated if cooked together. Additionally these contacting portions may be pre-cooked or not coated with oil to prevent sticking or cooking together. Separation may be accomplished by manually separating the product or connecting or separating pellets with material pegs 55 (e.g. food stuffs not coated with oil and not continuing water) which do not cook.

FIG. 8 shows a cross section of a food product, here ring food member 23, here a ling of edible material, which receives a coating 22 of pellet material. Unlike the normal pellet, this pellet encloses another food member. This food member 23 may be a real onion ring, a slice of potato, a meat product or the like. Whatever product is enclosed, it is fried and cooked in the microwave process which produces the cooked pellet as described herein.

An oil layer 24 is provided in order to provide the liquid for heating and cooking the pellet material and consequent heating of the food product, here food member 23. While the food member 23 here is a food ring, it may obviously be a non-pellet or different type of pellet edible member of any shape.

FIG. 8 shows a ring with an outer surface 37 and an inner surface 38. There is an internal area 39 which could be fully enclosed with pellet material or define an air pocket. If fully enclosed with pellet material, the oil 24 on the inner surface 38 would be inside of the pellet so produced.

As shown in FIG. 9, the microwave roasting package may comprise a bag 1 with at least two layers: an outer layer 10 prepared from a suitable paper product with an inner layer 11 comprised of a thinly extruded thermoplastic polymer. This is preferably a polyester between 70-100 gauge. The paper is typically discardable. The polymer is breathable. The paper may be used to impart shape to the breathable polymer and to assist in the separation of within the bag.

As shown in FIGS. 9-11 The top portion 12 of the kraft paper layer 10 may also include a small thumb notch 16 to assist in the packaging process. The peelable seal along the top edge of the bag is an easily separated film-to-film seam, this being the result of the manner in which the heat seal coating is applied and processed. In addition, there is no folded paper-to-paper seam along the top edge, which allows for easier opening by the consumer.

If the polymeric layer inner layer 11 is a thinly extruded, transparent film, then the outer paper layer 10 may optionally have a hole 18 cut in it to reveal the inner layer 1 1, thus producing a window through which the product may be viewed. This allows the user to observe the roasting product to determine if the roasting time has been sufficient. The window opening is not required to achieve the desired roasting, but is a beneficial option.

In the preferred embodiment, the package is folded so that the interior volume is approximately 22 fluid oz., the window 18 is about 1½ inches by 0.2½ inches and the thumb notch 16 is about ¼ inch by 1 inch.

The above-described package composition has been found to provide the optimum texture, crunchiness, and flavor for roasting nuts or seeds in a microwave oven. Although the leguminous product could be roasted in a plain paper sack, open dish, or conceivably any other microwavable container, the bag composition of the present invention allows the product to be thoroughly and evenly cooked while avoiding overcooking or burning, and allows the product to retain a pleasant flavor. The kraft paper outer layer 10 acts as an insulator, trapping heat on the inside of the package and allowing for easier handling while the contents of the package is still hot. Further, the bag composition described herein allows for a certain amount of the microwave heat to be transformed into thermal heat within the bag which assists in providing a more flavorful product with the desired texture.

For pellets, the paper outer layer is not necessary except to provide structure to the product.

FIG. 12 shows each individual pellet separated. This separation can be achieved by manually separating the pellets before cooking or by providing individually partially or completely sealed chambers 44.

Care should be taken that enough air remains in each chamber so that the heat can be transferred evenly and to allow expansion. When microwave roasting, a volumetric ratio from about 30% to 45% in the bag has been found to be minimal to provide even cooking, and preferably from about 33% to 38%. By way of example, 3.0 ounces of pellets may be placed into a 22 fluid ounce bag to provide optimum microwave cooking and also a good volume for consumption.

The pellets are roasted by placing them in a standard microwave oven and cooking until a desired texture is obtained. Some experimentation may be required to determine the optimum cooking times and heating levels based upon the materials used to construct the microwavable bag and the particular microwave oven used. It has been found that interrupting the cooking process in the middle, to flip the package, may improve the evenness of cooking. Using the preferred embodiment package, it has been found that optimum microwave cooking times range from about 20 seconds to about 1 minute at high cooking levels, depending upon the microwave oven used and the pellet. The optimum cooking times may vary, but minimal experimentation will reveal the preferred roasting times. Once exposed to the microwave energy for the desired time period, the bag should be removed from the microwave oven and allowed to cool without opening. This cooling period provides for continued thermal heating of the product and has been found to substantially affect the crunchiness of the product upon consumption. The pellets should be allowed to cool at least until they may be safely touched with bare hands. It has been found that longer cooling periods may increase the crunchiness.

As can best be seen by FIGS. 12 and 16 one way of dividing the package would be to have vertical seals 27 and horizontal seals 28 which separate the bag 1 into a grid which would hold one or more pellets. Here, for novelty and variety two types of pellets, solid pellets and ring pellets 23 are shown. 23 and 15. In this case, the pellets are different shape in order to provide additional novelty.

In this case, one pellet is more or less a solid pellet 15 and the other one is a pellet defining an opening (23 in FIG. 8) such as a ring pellet 23.

FIG. 16 shows a side view through the 16-16 axis of FIG. 12.

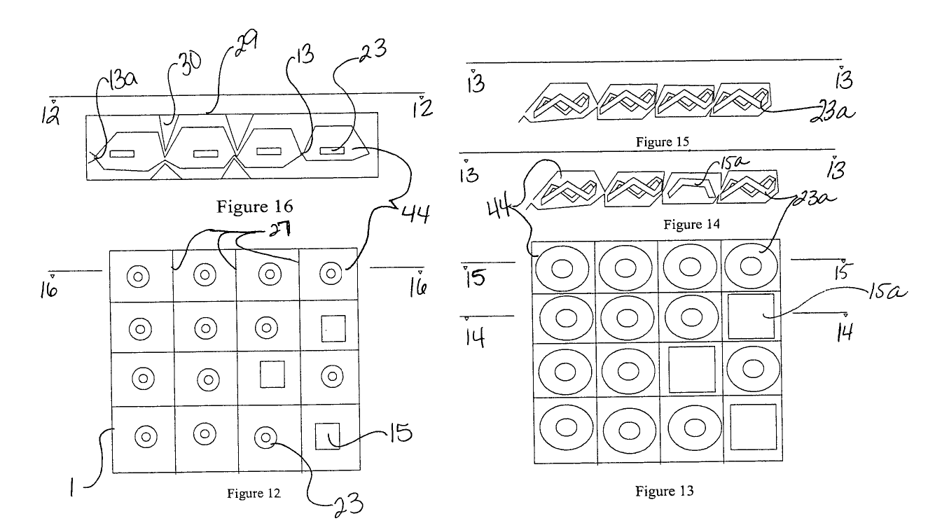

As can be seen, each of the chambers defines an open area 44 which open area it will ultimately be filled as the pellet is fried and expands as shown in FIGS. 13-15.

The individual chambers 44 may be separated using an adhesive 13 which may be a heat releasing adhesive so the bag opens upon heating. The separation may be accomplished through crimping the package (aided with a stiff paper floor or exterior) or welding the bag 1 together at the horizontal and vertical lines. The adhesive 13 or crimping may be made so that under the pressure of expansion they break so that one continuous bag is left at the end of the process.

The bag itself may be sealed with a stronger adhesive here shown as 13a which would not break under the heat to prevent spillage.

In FIG. 16 it is shown how an external paper container may maintain the crimping (reduced diameter 49) by having a stiff paper container 29 which defines ridges 30 would serve to separate the individual chambers 44.

FIGS. 13, 14 and 15 show different views of the container shown in FIGS. 11 and 12 after frying when the pellets 23 and 15 have been expanded to form a cooked product 23a and 15a.

Referring to FIG. 14, it can be seen that the shape of the pellets may become irregular upon frying so that the product has more dimension then what might originate as essentially flat pellets based on the frying and popping process.

Starch provides for the popping and may be substituted with other products which would provide a similar function (as does moisture) whereas the flour provides the nutrition and taste of the product.

By eliminating, for example, the horizontal seals 28, tubes may be formed (as shown in FIGS. 3 and 7) and if the products originate with irregular shapes such as those shown in FIGS. 14 and 15, then the irregular shapes may serve to keep them spaced out sufficiently in order to allow the product to be made without having both vertical and horizontal seals.

Alternatively, one step in the method would be for the user to separate the products out within the bag without horizontal or vertical seals so that the product would be separated essentially as shown in FIG. 12 without the seals in order to allow the product to be cooked evenly as described below.

It can also be seen that the free space in the chambers 44 is decreased substantially after the popping of the pellets, shown in their expanded form as 23a and 15a.

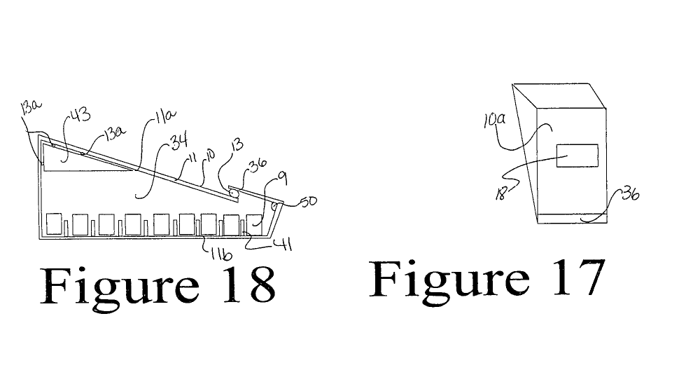

FIGS. 17 and 18 show a package designed to separate and prevent crushing of the pellets. Particularly with a paper outer layer 10, this package may have a shell of paper (layer 10) which keeps the package expanded. A series of baffles 41 within the package may serve to hold the pellets separated

As can best be seen by reference to FIG. 18, there is a central chamber 34 into which pellets 9 are inserted separated by baffles 41. These baffles may be edible material, unfrying and unexpanding material and may be connected or separated from the pellets 9.

The pellets may be held within the baffles by a collapsing inner paper shell 43. This inner paper shell 43 may be made of other suitable material but should easily collapse under pressure from the expansion.

This inner shell may be held by spots of glue 13a along the top slanting face 11a of the inner layer 11.

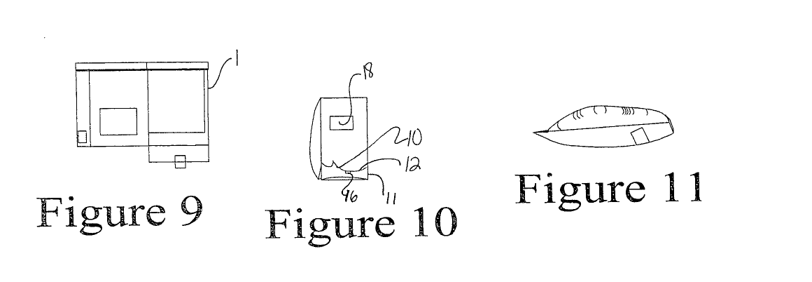

The outer layer 10 on the outer slanting face 10a can define a window for in hole 18 as shown in FIG. 10 in order to view the popping process or the stiff outer layer may 10 may be made out of clear material.

In the embodiment shown in FIG. 18, the baffles 41 are attached to the bottom 11b of the inner layer 11.

The angle 50 in the outer layers 11 and 10 allows for additional movement of the package in response to pressure from the expansion just as the item 23 allows for expansion as shown in FIG. 5.

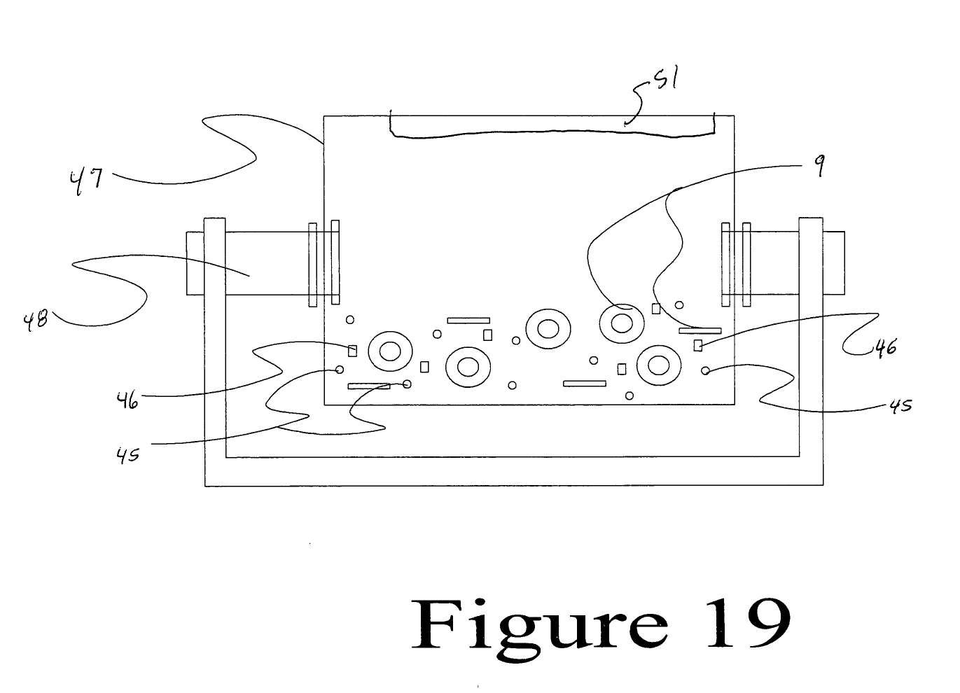

FIG. 19 shows how a tumbler 47 may be used to coat the pellets with oil 45 and flavoring 46. This comprises a barrel 47 on a spindle 48. Baffles or paddles 51 may be used to increase the shuffling of the product within the barrel.

The method may be described as selecting at least one fryable food which is preferably a pellet comprised of flour and starch in proportions in order to provide that upon heating the product expands without breaking and wherein the flour and starch are typically from a group comprised of potato wheat, corn, bran, rice or combinations thereof.

Next, the fryable food is ground, mixed with spices and dried or mixed with moisture or other binding substances, and compressed into a pellet with a surface and an interior. The surface is then coated at least partially with the microwave heatable substance which is in this case preferably oil. A different pellet or a food such as a ring of onion, potato or meat may be coated with this pellet material.

The product may be simultaneously or subsequently or previously coated with a flavoring which is preferably lightly flavored in a compressed format (such as finely ground spices and salt).

The product is typically covered with a breathable cover for containing steam and heat and some of the air and then microwaved producing a low oil cooked product. Preferably the breathable cover is polyester which has a thickness of 70-100 gauge, and is sealed around the product at least during the cooking process.

Another step in the cooking process immediately before microwaving is to manually or with baffles or chambers separate the individual products from one another.

As discussed before, one method of separating pellets would be to have them connected with an edible or an inedible connection which edible or inedible connection does not expand greatly and allows the product to expand but keeps them separated during the expansion process.

One way of concentrating the flavoring would be to have it finely ground or concentrated.

Some of the fryable or heatable substance can be added to the interior of the pellet and typically this would involve at least a small amount of moisture which helps form a past of flour, water and starch.

The pellets may be shaped in a mold or by extrusion in order to obtain a desired effect or in order to provide that more surface area is open to the coating process.

Because many varying and different embodiments may be made within the scope of the inventive concept herein taught and because many modifications may be made in the embodiment(s) herein detailed in accordance with the descriptive requirements of the law, it is to be understood that the details herein are to be interpreted as illustrative and not in a limiting sense.

1. I claim a method for producing foods which may be cooked in the presence of microwave energy comprising the steps of:
a) selecting at least one fryable food product;
b) compressing the food product into a pellet with a surface and an interior;
c) coating at least a portion of the surface with a microwave heatable substance.

2. The method of claim 1 further comprising the step of enclosing the food product in a partially breathable cover.

3. The method of claim 2 wherein the breathable cover is polyester.

4. The method of claim 3 wherein the polyester is of a thickness between 70-100 gauge.

5. The method of claim 1 wherein the food product is comprised of flour and starch.

6. The method of claim 5 wherein the product farther comprises water.

7. The method of claim 6 wherein the flour is from a group consisting of potato, wheat, corn, bran, rice or combinations thereof.

8. The method of claim 1 further comprising the step of selecting at least one flavoring and combining at least a portion of the pellet with said flavoring. (and wherein the flavoring is finely ground or concentrated)

9. The invention of claim 1 wherein the step of compression comprises grinding the food product into a paste and mixing with moisture

10. The method of claim 1 wherein the step of routing comprises coating the pellet with oil.

11. The method of claim 1 further comprising the step of separating the pellets and microwaving the separated pellets.

12. The method of claim 1 further comprising packaging a plurality of pellets, comprised of at least one first pellet and at least one second pellet in a microwavable container having a top and a bottom layer of heat resistant plastic.

13. The method of claim 12 wherein the container allows the passage of air but provides a moisture and heat barrier.

14. The method of claim 12 wherein the container provides a separating means for separating the pellets from one another.

15. The method of claim 14 wherein the separating means comprises at least one seal within the container between at least one pellet and at least one second pellet.

16. The method of claim 15 wherein the seal is comprised of a fold in the material.

17. The method of claim 14 wherein the seal is comprised of and adhesive between the top layer and the bottom layer of the container.

18. The method of claim 14 wherein the seal comprises at least one baffle extending from the bottom layer toward the top layer.

19. The method of claim 1 wherein the step of selecting comprises the step of selecting at least one second food product and coating the at least one second food product and with the at least one food product further comprising the steps of adding a second layer of product.

20. A microwavable pellet comprised of:
a) a milled flour;
b) a milled starch;
c) an oil coating.
